(19) United States
(12) Patent Application Publication
(10) Pub. No.: US 2010/0185623 A1
(43) Pub. Date: Jul. 22, 2010

(54) TOPICAL RANKING IN INFORMATION RETRIEVAL

(76) Inventors: Yumao Lu, San Jose, CA (US); Benoit Dumoulin, Palo Alto, CA (US)

Correspondence Address: YAHOO! INC. C/O GREENBERG TRAURIG, LLP, MET LIFE BUILDING, 200 PARK AVENUE, NEW YORK, NY, 10166, US

(21) Appl. No.: 12/354,533

(22) Filed: Jan. 15, 2009

(51) Int. Cl. G06F 17/30

(52) U.S. Cl. 707/748; 707/E17.008; 707/E17.017; 707/736

(57) ABSTRACT

An aggregate ranking model is generated, which comprises a general ranking model and one or more topical training models. Each topical ranking model is associated with a topic, or topic class, and for use in ranking search result items determined to belong to the topic, or topic class. As one example, the topical ranking model is trained using a set of topical training data, e.g., training data determined to belong to the topic, or topic class, a general ranking model and a residue, or error, determined from a general ranking generated by the general ranking model for the topical training data, with the topical ranking model being trained to minimize the general ranking model's error in the aggregate ranking model.

### FIELD OF THE DISCLOSURE

The present disclosure relates to ranking items, such as web documents, in information retrieval, such as a web search, results, and more particularly to topical ranking of items in information retrieval, or search, results.

### BACKGROUND

Typically, items in a set of search results generated in an information retrieval system, such as a web search system, are ranked. An item's ranking can be used to determine whether the item is culled from the set of search results, or if it is retained the order that the item appears in the set of search results, for example. Ranking is typically based on relevance to a query that contained criteria, or query term, used to retrieve, or search for, the search results.

A conventional information retrieval system uses a general ranking model, i.e., a model that is trained using a large body of query-document pairs, each pair having statistically-determined values for features identified in the query, the document or both. The general ranking model can be used effectively to rank search results for the more common queries, or query terms.

### SUMMARY

The present disclosure seeks to address failings in the art and to supplement a general ranking model with one or more specific, or sub-, models, which can be used with the general ranking model to rank items in a set of search results. The present disclosure provides a system and method for topical ranking in information retrieval. In accordance with one or more embodiments, ranking refers to a relevance ranking, and a relevance ranking score for an information item, e.g., an information item contained in a set of search results, refers to a measure of relevance of an information item to a query, or query term.

Disclosed herein is system and method to generate an aggregate ranking model which comprises a general ranking model and one or more topical training models. Each topical ranking model being associated with a topic, or topic class, and for use in ranking search result items determined to belong to the topic, or topic class. In accordance with one or more embodiments, the topical ranking model is trained using a set of topical training data, e.g., training data determined to belong to the topic, or topic class, together with a general ranking model.

In accordance with one or more embodiments, a topical ranking model is trained using a ranking score generated by a general ranking model and an ideal ranking score. In accordance with one or more such embodiments, a general ranking error is determined as the difference between the general ranking and ideal ranking scores, and the topical ranking model is trained so as to minimize the ranking error.

By virtue of arrangement described herein, for example, a ranking score output by the topical ranking model can be used to supplement the ranking score output by the general ranking model for a search result item, so as to generate an aggregate score for the search result item that minimizes an error introduced by the general ranking model. Such an error can be introduced by ranking using a general ranking model, since the general ranking model can discount sparse features, e.g., features that are used in a small subset of queries, and/or topical, or semantic, features associated with a topic or class of topics.

In accordance with one or more embodiments, a method is provided, by which topical training data is obtained, the topical training data comprising query document pairs determined to belong to a topical class, and a topical ranking model for the topical class is trained using the general ranking model and the topical training data.

In accordance with one or more other embodiments, a system is provided, which comprises a topical training set selector configured to obtain a training set comprising at least one query document pair determined to belong to a topical class, and a trainer configured to train a topical ranking model for the topical class using a general ranking model and the topical training data.

In accordance with one or more further embodiments, a computer-readable medium is provided, which has computer-executable program code tangibly stored thereon, the program code to obtain topical training data comprising at least one query document pair determined to belong to a topical class; and train a topical ranking model for the topical class using a general ranking model and the topical training data.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a computer-readable medium.

### DRAWINGS

The above-mentioned features and objects of the present disclosure will become more apparent with reference to the following description taken in conjunction with the accompanying drawings wherein like reference numerals denote like elements and in which:

FIG. 1 provides an overview of information retrieval and ranking components that use a topical ranking model in accordance with one or more embodiments of the present disclosure.

FIG. 2 provides an overview of topical ranking model generation components for use in accordance with one or more embodiments of the present disclosure.

FIG. 3 provides a topical ranking model generation process flow for use in accordance with one or more embodiments of the present disclosure.

FIG. 4 provides a query document pair training process flow for use in accordance with one or more embodiments of the present disclosure.

FIG. 5 illustrates some components that can be used in connection with one or more embodiments of the present disclosure.

### DETAILED DESCRIPTION

In general, the present disclosure includes a topical ranking system, method and architecture.

Certain embodiments of the present disclosure will now be discussed with reference to the aforementioned figures, wherein like reference numerals refer to like components.

In accordance with one or more embodiments, a topical ranking model, which is used with a general ranking model, to rank items in a set of search results, is trained using the general ranking model. In accordance with one or more embodiments, more than one topical ranking model can be used a general ranking model to rank search result items. Each topical ranking model is associated with a topic, or topic class, and is used in ranking search result items, which have features, e.g., semantic features, associated with the topic, or topic class.

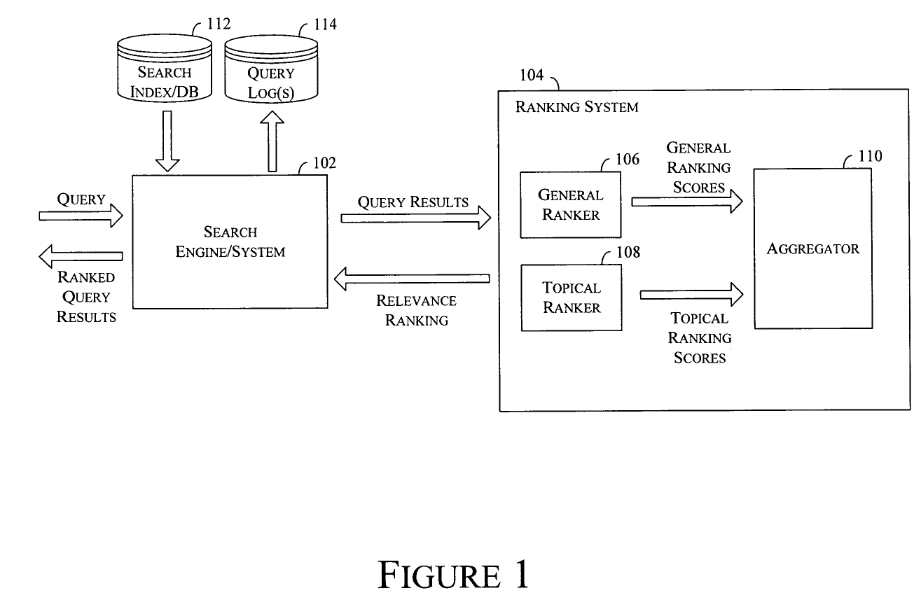

FIG. 1 provides an overview of information retrieval and ranking components that use a topical ranking model in accordance with one or more embodiments of the present disclosure. A query is input to search engine, or search system, 102, which searches one or more instances of a search index, or database, to identify a set of search results for the query. One or more query logs 114 can be maintained, e.g., one or more logs containing information to identify queries received by search engine 102 and search results associated with each query. In accordance with one or more embodiments, a query log 114 includes information to identify a query and each document included in the search results, together with a set of features determined for each query document pair.

Search engine 102 forwards the query results to a ranking system 104, which generates relevance ranking scores for the query result items. The relevance ranking scores are forwarded to search engine 102, which uses the ranking scores to rank the query result items. In accordance with one or more embodiments, the ranking scores can be used to order the search result items, and/or to cull, or remove, items from a search results. By way of some non-limiting examples, an item can be removed in a case that the item's ranking score falls below a threshold ranking. By way of another non-limiting example, an item can be removed if it is not one of n items, e.g., top n items determined based on the ranking scores associated with the items.

In accordance with one or more embodiments, ranking system 104 comprises at least one general ranker 106, at least one topical ranker 108 and an aggregator 110. Aggregator 110 generates a relevance ranking for an item using the at least one general ranker 106 and the at least one topical ranker 108.

By way of a non-limiting example, an instance of topical ranker 108 may exist for different topics, or topic classes. In accordance with one or more embodiments, each topical ranker, or topical ranking model, 108 is trained using a set of topical training data, e.g., training data determined to belong to the topic, or topic class. General ranker, or general ranking model, 106 is also used in one or more embodiments, together with ideal ranking input associated with the topical training data. In accordance with one or more such embodiments, the topical ranking model is trained so as to minimize a ranking error determined for the general ranking model. By way of a non-limiting example, the general model's ranking error for an item in the topical training set is determined to be a difference between a ranking score output by the general ranker 108 and an ideal ranking score for the topical training data set item.

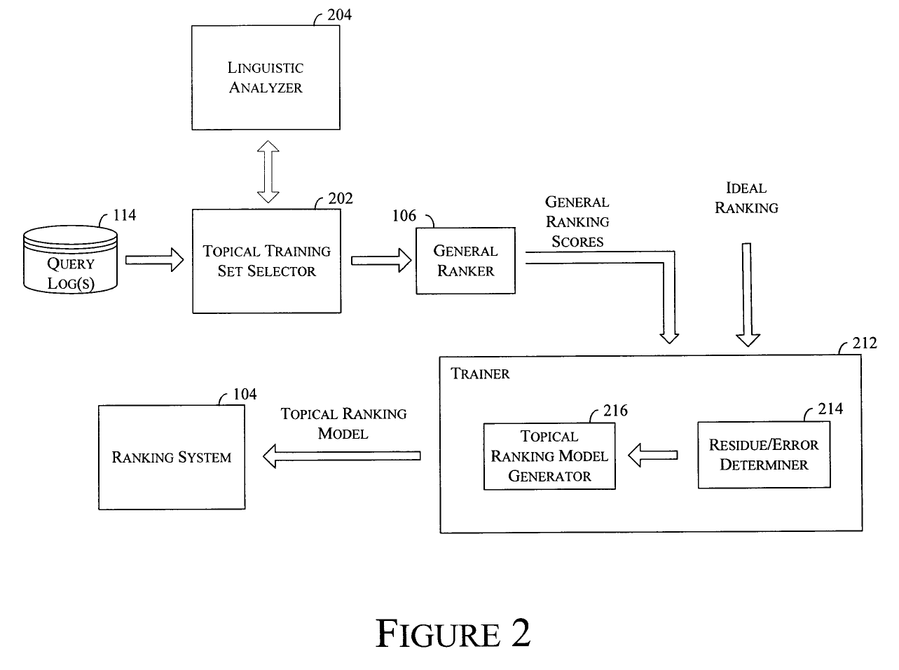

FIG. 2 provides an overview of topical ranking model generation components for use in accordance with one or more embodiments of the present disclosure. Trainer 212 has as input general ranking and ideal ranking scores for a set of topical training data. The topical training data comprises a set of query document pairs, e.g., each pair identifying a query, a document identified using the query, and a set of features. The query document pairs included in the topical training data are determined to belong to a topic or topic class. In accordance with one or more embodiments, a topical training data set is selected using a selector 202. Selector 202 can comprise, or otherwise use, a query linguistic analyzer 204, which segments the query into one or more tags. Each tag has a tag value, e.g., the portion, or segment of the query, and a type, e.g. a semantic concept, meaning, or category determined for the query segment. By way of a non-limiting example, a segment, bank of america, of the query james bond breaks bank of america has a tag value of bank of america, and has a tag type of business name. The output of query linguistic analyzer 204, e.g., tag and tag type, is used by selector 202 to determine whether a query document pair belongs to a topic or topic class. By way of some non-limiting examples, a tag having a product-related type, such as product brand, manufacturer name, model number, etc., can be considered to belong to a product topic class; and person-related tags, e.g.,person name tag type can be considered to belong to a person class. More than one tag type can be used to identify a topic or topic class. By way of another non-limiting example, a query that contains tags of type business name and a location-related tag type, such as street name, city name, state name, etc., can be considered to belong to a local query topic class.

Selector 202 selects query document pairs from query logs 114 for a topic or topic class using type information, e.g., tag type output by the query linguistic analyzer, to generate a set of topical training data for a topic or topic class. The topical training data set is input to general ranker 106 to generate general ranking scores for each of the query document pairs in the topical training data set. In addition, a topical training data set is provided to one or more human editors to provide an ideal ranking score for each of the query document pairs in the topical training data set.

In accordance with one or more embodiments, each query document pair in the topical training data set selected by selector 202 has a feature set, which can be the same or different from the feature set of another query document pair in the topical training data set. In accordance with one or more embodiments, the feature set for a query document pair in the topical training set can comprise semantic features. In accordance with one or more embodiments, a semantic feature can be a feature that relates to a tag type, or tag types, identified for the query, or query segment. In accordance with one or more embodiments, a value for a semantic feature can be determined based on semantic matching. Examples of semantic features include, without limitation, ftagbn, which identifies a number of business entities found in the query; ftagb, a logical value indicating whether the query identifies a business entity or not; ftagln, which identifies a number of location entities found in the query; and ftagl, a logical value indicating whether the query is a location or not. Other examples of semantic features include, without limitation, semantic proximity features, such as semantic minimum coverage, the value of which can identify a length of the shortest document segment that covers a semantic term, e.g., a tag type, such as business name, of the query in a document, and semantic moving average BM25, which relates to a frequency of a semantic term in the document. These and other examples of semantic features can be found in commonly-assigned U.S. Patent Application, entitled System and Method For Ranking Web Searches With Quantified Semantic Features, filed mm/dd/yyyy, and assigned U.S. patent application Ser. No. ______, (Yahoo! Ref. No. Y05031US00, Attorney Docket No. 085804-098300), which is incorporated herein by reference in its entirety.

In accordance with one or more embodiments, trainer 212 comprises a residue, or error, determiner 214, and a topical ranking model generator 216. In accordance with one or more such embodiments, determiner 214 determines a residue, or error, for each query document pair using the general ranking and ideal ranking scores for the query document pair. By way of a non-limiting example, determiner 214 determines the residue, or error, to be a difference between the general ranking and ideal ranking scores. Topical ranking model generator 216 trains a topical ranking function, which can be used for a topical ranker 108, such that the residue, or error, for the query document pair is minimized. The topical ranking function generated by topical ranking model generator 206 is provided to ranking system 104, which uses it for one of the topical rankers 108.

In accordance with one or more embodiments, a topical ranking function, g(w) generated by trainer 212 minimizes an overall residue, or error, for the topical training data set, which overall residue, or error, can be expressed as follows:

$${\sum }_{i = 1}^{n} {( g ( {w}_{i} ) - {r}_{i} )}^{2} , \qquad ( 1 )$$

where n is the number of query document pairs in the topical training data set, i is a counter from 1 to n representing the current query document pair in the topical training data set, wᵢ is a dynamic feature set for the current query document pair's query, and rᵢ is a residue, or error, associated with the current query document pair. In accordance with one or more embodiments, a dynamic feature set is topic-related and can vary from one query to the next and from one topic to the next. In accordance with one or more such embodiments, in other words, a feature set can depend on a query and/or a topic identified from the query portion of a query document pair in the topical training data set.

As the value of g(wᵢ) and rᵢ approach each other, the overall ranking error introduced by the general ranking model approaches zero. In other words and in accordance with one or more embodiments, trainer 212 generates a topical ranking model to cancel out, or offset, the error generated by the general ranking model.

In the examples shown in FIGS. 1 and 2, components, e.g., search engine 102 and ranking system 104, which are depicted as separate components can be combined as a single component. Conversely, it should be apparent that a single component, e.g., trainer 212, depicted in FIGS. 1 and 2 can be divided into two or more components. In accordance with one or more embodiments, components depicted in FIGS. 1 and 2, e.g., search engine 102, ranking system 104, topical training set selector 202, linguistic analyzer 204, trainer 212, etc. can be implemented in hardware, software, e.g., software which is executable by a computing device, or a combination of hardware and software.

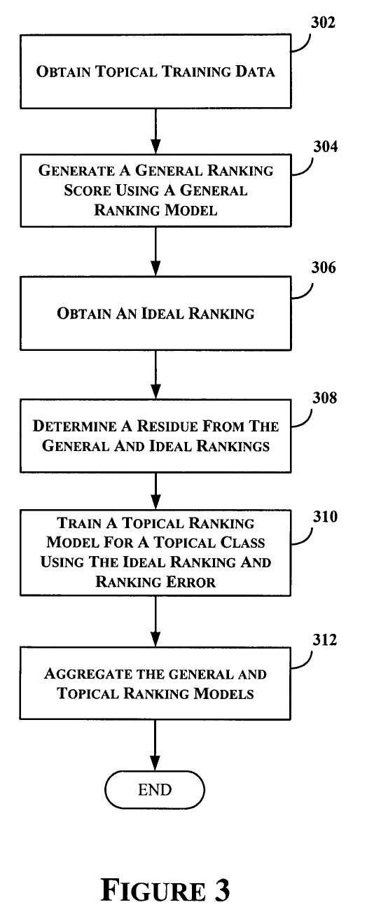

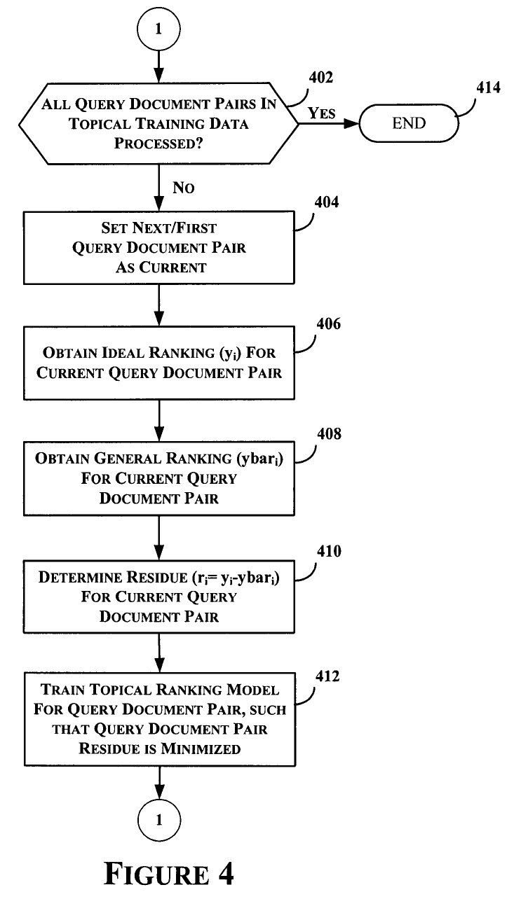

In accordance with one or more embodiments, a method of training a topical ranking model comprises obtaining topical training data, which comprises at least one query data pair determined to belong to a topical class, and training the topical ranking model for the topical class using a general ranking model and the topical training data. By way of a non-limiting example, the method can be implemented by one or more computing systems. In accordance with one or more embodiments, a process flow described herein can be implemented by one or more components described herein. In accordance with one or more embodiments, a method is provided, which can comprise some or all of the process flow of FIG. 3 and/or FIG. 4, which provides a topical ranking model generation process flow for use in accordance with one or more embodiments of the present disclosure.

Referring to FIG. 3, topical training data is obtained at step 302. By way of a non-limiting example, topical training data can be selected by a topical training set selector 202, which uses information provided by an analysis of one or more queries from a set of candidate query document pairs. By way of a further non-limiting example, the candidate query document pairs can be taken from query log(s) 114. In accordance with one or more embodiments, the topical training set comprises a fraction, such as without limitation approximately 1/10^{th}, of the training data used to train the general ranking model. Advantageously, using such a training data set size results in less cost and a shorter training cycle. In accordance with one or more embodiments, human editors provide an ideal ranking. Accordingly and advantageously, the cost associated with obtaining an ideal ranking from human editors can be minimized using a small training data set. At step 304, a general ranking score is generated using a general ranking model, e.g., a general ranking function implemented by general ranker 106. In accordance with one or more embodiments, a general ranking score is generated for each query document pair contained in the topical training data set.

At step 306, an ideal ranking is obtained. In accordance with one or more embodiments, and ideal ranking score is obtained for each query document pair contained in the topical training data set. At step 308, a residue, or error, is determined using the general and ideal rankings. In accordance with one or more embodiments, a residue, or error, is determined for each query document pair contained in the topical training set.

At step 310, a topical ranking model is trained for the topical class using the ideal ranking and the determined ranking error. In accordance with one or more embodiments, the topical ranking model is trained using the obtained ideal rankings and determined ranking errors for all of the query document pairs in the topical training set. At step 312, the general and topical ranking models are used in the aggregate to rank an item in a set of search results.

As discussed above in connection with FIG. 3, in accordance with one or more embodiments, all of the query document pairs contained in a topical training data set can be used to train a topical ranking model. In accordance with one or more embodiments, for each query document pair in a topical training data set, the topical ranking model is trained so as to offset an error introduced by a general ranking model ranking for the query document pair. As shown in the example of expression (1) above, the topical ranking model is trained so as to generate a ranking score that approaches or equals the error introduced by the general ranking model for each query document pair in the topical training data set. FIG. 4 provides a query document pair training process flow for use in accordance with one or more embodiments of the present disclosure.

At step 402, determination is made whether or not all the query document pairs in the topical training data set have been processed. If so, processing ends at step 414. If not, processing continues at step 404 to set the next, or first, query document pair in a topical training data set as the current query document pair. At step 406, and ideal ranking, yᵢ, is obtained for the current query document pair. At step 408, a general ranking score, ybarᵢ, is obtained for the current query document pair using the general ranking model. By way of a non-limiting example, where the general ranking model is expressed as a function, f, the general ranking score can be obtained using the following exemplary expression:

ybarᵢ=f(xᵢ), (2)

where xᵢ is a set of features associated with the current query document pair, i, which is input to the general ranking model, and then used by the general ranking model, to generate the general ranking score, ybarᵢ, for the current query document pair.

At step 410, a residue, or error, is determined for the current query document pair. In accordance with one or more embodiments, the residue, or error, can be determined using the following expression:

rᵢ=yᵢ−ybarᵢ, (3)

where rᵢ is the residue, or error, for the current query document pair, i, and yᵢ is the ideal ranking for the current query document pair.

At step 412, the topical ranking model is trained using the ideal ranking score, yᵢ, and the residue, rᵢ, for the current query document pair, so as to minimize the residue/error associated with the current query document pair's general ranking. Processing continues at step 402 to determine whether or not any query document pairs in the topical training data remain to be processed.

Referring again to step 312 of FIG. 3, the aggregate of the general and topical ranking models can be expressed using the following exemplary expression:

f(x)+g(w), (4)

wherein f represents a general ranking function used by the general ranking model to rank an item using a set of features, x, e.g., non-semantic features, defined for the general model; g represents a topical ranking function used by a topical ranking model to rank an item using a set of features, w, e.g., semantic features of a topic or topic class, defined for the topical ranking function/model. In accordance with one or more embodiments, given sets of features, x and w, for a search result item, an aggregate ranking score can be determined using the general ranking model and a topical ranking model. In accordance with one or more embodiments, g(w) can comprise more than one topical ranking model, each of which is determined in accordance with one or more embodiments disclosed herein.

From a general perspective, an aggregate ranking model, which implements one or more topical ranking functions, g(w), determined using one or more embodiments of the present disclosure, and a general ranking function,f(x), minimizes an overall error, such that:

|f(x)+g(w)−y| (5)

is zero or approaches zero, where y is an ideal rank score, e.g., an ideal rank score for a search result item, which has features from feature sets, x and w. As an alternate expression,

|f(x)+g(w)|=|y| (6)

In accordance with one or more embodiments, a ranking function can be learned, or trained, using a variety of approaches, including a regression or linear regression approach. Linear regression can directly calculate an optimal set of weights for one or more features used by the ranking model, so as to identify a value, e.g., a weight, for one or more features in a feature set, so as to minimize an error, such as the ranking error determined in accordance with one or more embodiments. In accordance with one or more embodiments, a decision tree approach can be used to generate a ranking function. In accordance with at least one embodiment, a stochastic gradient boosting tree approach can be used to train a topical ranking function, or model.

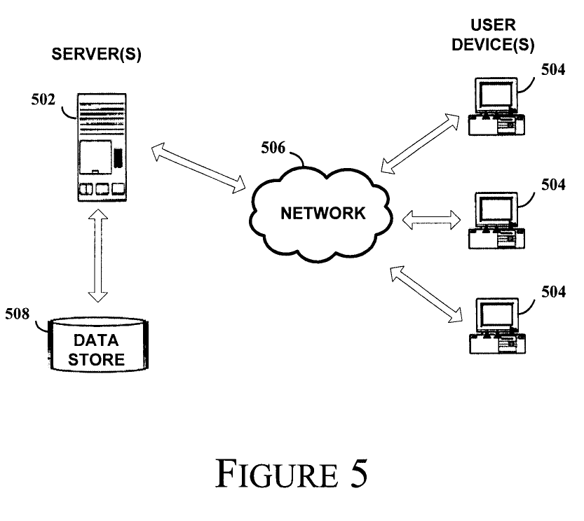

FIG. 5 illustrates some components that can be used in connection with one or more embodiments of the present disclosure. In accordance with one or more embodiments of the present disclosure, one or more computing devices are configured to comprise functionality described herein. For example, one or more servers 502 can be configured to include one or more of search engine/system 102, ranking system 104, topical training set selector 202, linguistic analyzer 204, and trainer, or training system, 212 in accordance with one or more embodiments of the present disclosure.

Computing device 502 can serve content to user computing devices, e.g., user computers, 504 using a browser application via a network 506. Data store 508, which can comprise one or more data stores, can be used to store search index/database 112 and/or query log(s) 114. In addition, data store 508 can store program code to configure one or more of instances of server 502 to execute search engine/system 102, ranking system 104, topical training set selector 202, linguistic analyzer 204, and trainer, or training system, 212, etc.

The user computer 504 can be any computing device, including without limitation a personal computer, personal digital assistant (PDA), wireless device, cell phone, internet appliance, media player, home theater system, and media center, or the like. For the purposes of this disclosure a computing device, e.g., server 502 or user device 504, includes one or more processors, and memory for storing and executing program code, data and software, and may be provided with an operating system that allows the execution of software applications in order to manipulate data. A computing device such as server 502 and the user computer 504 can include a removable media reader, network interface, display and interface, and one or more input devices, e.g., keyboard, keypad, mouse, etc. and input device interface, for example. One skilled in the art will recognize that server 502 and user computer 504 may be configured in many different ways and implemented using many different combinations of hardware, software, or firmware.

In accordance with one or more embodiments, a server 502 can make a user interface available to a user computer 504 via the network 1206. The user interface made available to the user computer 504 can include content items, or identifiers (e.g., URLs) selected for the user interface based on usefulness prediction(s) generated in accordance with one or more embodiments of the present invention. In accordance with one or more embodiments, computing device 502 can make a user interface available to a user computer 504 by communicating a definition of the user interface to the user computer 504 via the network 506. The user interface definition can be specified using any of a number of languages, including without limitation a markup language such as Hypertext Markup Language, scripts, applets and the like. The user interface definition can be processed by an application executing on the user computer 504, such as a browser application, to output the user interface on a display coupled, e.g., a display directly or indirectly connected, to the user computer 504. In accordance with one or more embodiments, a user can use the user interface to input a query that is transmitted to search engine/system 102 executing at a server 502. Server 502 can provide a set of ranked query results to the user via the network and the user interface displayed at the user device 504.

In an embodiment the network 506 may be the Internet, an intranet (a private version of the Internet), or any other type of network. An intranet is a computer network allowing data transfer between computing devices on the network. Such a network may comprise personal computers, mainframes, servers, network-enabled hard drives, and any other computing device capable of connecting to other computing devices via an intranet. An intranet uses the same Internet protocol suit as the Internet. Two of the most important elements in the suit are the transmission control protocol (TCP) and the Internet protocol (IP).

It should be apparent that embodiments of the present disclosure can be implemented in a client-server environment such as that shown in FIG. 5. Alternatively, embodiments of the present disclosure can be implemented other environments, e.g., a peer-to-peer environment as one non-limiting example.

For the purposes of this disclosure a computer readable medium stores computer data, which data can include computer program code executable by a computer, in machine readable form. By way of example, and not limitation, a computer readable medium may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method comprising:
obtaining topical training data comprising at least one query document pair determined to belong to a topical class; and
training a topical ranking model for the topical class using a general ranking model and the topical training data.

2. The method of claim 1, further comprising:
ranking a search result item comprising:
generating a general ranking for the search result item using the general ranking model;
generating a topical ranking for the search result item using the topical ranking model; and
aggregating the general and topical rankings.

3. The method of claim 1, said training a topical ranking model further comprising:
determining a general ranking for each query document pair in the topical training data using the general ranking model;
determining a general ranking error for each general ranking determined by the general ranking model;
training the topical ranking model for the topical class using the ranking error for each general ranking determined by the general ranking and an ideal ranking associated with the general ranking.

4. The method of claim 3, said determining a ranking error further comprising:
determining a difference between the general ranking and the associated ideal ranking.

5. The method of claim 4, further comprising:
receiving ranking input, as the ideal ranking, from at least one human editor.

6. The method of claim 3, wherein at least one feature is associated with the topical training data, the at least one feature being used to rank the query document pair.

7. The method of claim 6, wherein:
said determining a general ranking for each query document pair further comprises using the at least one feature as input to the general ranking model to determine the general ranking for the query document pair; and
said training the topical ranking model further comprises training the topical ranking model to minimize the error with respect to the at least one feature.

8. The method of claim 7, said training the topical ranking model further comprising:
training said topical ranking model to minimize an overall error associated with the topical training data as a whole.

9. The method of claim 6, wherein the at least one feature is determined using a query portion of a query document pair.

10. The method of claim 9, wherein the at least one feature is a semantic feature associated with the topical class.

11. The method of claim 6, wherein the at least one feature has a first contribution to the general ranking score determined using the general ranking model for the query document pair, and has a second contribution to the topical ranking score determined using the topical ranking model for the query document pair, the second contribution being determined so as to minimize an error associated with the general ranking model.

12. The method of claim 1, wherein the topical class has at least one topic, and wherein each query document pair in the topical training data is determined to relate to the at least one topic.

13. The method of claim 12, further comprising:
analyzing a query portion of a candidate query document pair to identify topic information for the query; and
determining whether or not to include the candidate query document pair in the topical training data using the topical class' at least one topic and the topic information determined for the query.

14. A system comprising:
a topical training set selector configured to provide topical training data comprising at least one query document pair determined to belong to a topical class; and
a trainer configured to train a topical ranking model for the topical class using a general ranking model and the topical training data.

15. The system of claim 14, further comprising:
a ranker configured to rank a search result item, the ranker comprising:
a general ranker configured to generate a general ranking for the search result item using the general ranking model;
a topical ranker configured to generate a topical ranking for the search result item using the topical ranking model; and
an aggregator configured to aggregate the general and topical rankings.

16. The system of claim 14, said trainer configured to train a topical ranking model further comprising:
a general ranker configured to determine a general ranking for each query document pair in the topical training data using the general ranking model;
an error determiner configured to determine a general ranking error for each general ranking determined by the general ranking model;
said trainer configured to train the topical ranking model for the topical class using the ranking error for each general ranking determined by the general ranker and an ideal ranking associated with the general ranking.

17. The system of claim 16, said error determiner configured to determine a ranking error further configured to determine a difference between the general ranking and the associated ideal ranking.

18. The system of claim 17, further comprising:
a receiver configured to receive ranking input, as the ideal ranking, from at least one human editor.

19. The system of claim 16, wherein at least one feature is associated with the topical training data, the at least one feature being used to rank the query document pair.

20. The system of claim 19, wherein:
said general ranker configured to determine a general ranking for each query document pair further configured to use the at least one feature as input to the general ranking model to determine the general ranking for the query document pair; and
said trainer configured to train the topical ranking model further configured to train the topical ranking model to minimize the error with respect to the at least one feature.

21. The system of claim 20, said trainer configured to train the topical ranking model further configured to train said topical ranking model to minimize an overall error associated with the topical training data as a whole.

22. The system of claim 19, wherein the at least one feature is determined using a query portion of a query document pair.

23. The system of claim 22, wherein the at least one feature is a semantic feature associated with the topical class.

24. The system of claim 19, wherein the at least one feature has a first contribution to the general ranking score determined using the general ranking model for the query document pair, and has a second contribution to the topical ranking score determined using the topical ranking model for the query document pair, the second contribution being determined so as to minimize an error associated with the general ranking model.

25. The system of claim 14, wherein the topical class has at least one topic, and wherein each query document pair in the topical training data is determined to relate to the at least one topic.

26. The system of claim 25, further comprising:
an analyzer configured to analyze a query portion of a candidate query document pair to identify topic information for the query; and
a topical class determiner configured to determine whether or not to include the candidate query document pair in the topical training data using the topical class' at least one topic and the topic information determined for the query.

27. Computer-readable medium tangibly embodying program code stored thereon, the program code comprising:
code to obtain topical training data comprising at least one query document pair determined to belong to a topical class; and
code to train a topical ranking model for the topical class using a general ranking model and the topical training data.

28. The medium of claim 27, said program code further comprising:
code to rank a search result item comprising:
code to generate a general ranking for the search result item using the general ranking model;
code to generate a topical ranking for the search result item using the topical ranking model; and
code to aggregate the general and topical rankings.

29. The medium of claim 27, said code to train a topical ranking model further comprising:
code to determine a general ranking for each query document pair in the topical training data using the general ranking model;
code to determine a general ranking error for each general ranking determined by the general ranking model;
code to train the topical ranking model for the topical class using the ranking error for each general ranking determined by the general ranking and an ideal ranking associated with the general ranking.

30. The medium of claim 29, said code to determine a ranking error further comprising:
code to determine a difference between the general ranking and the associated ideal ranking.

31. The medium of claim 30, said program code further comprising:
code to receive ranking input, as the ideal ranking, from at least one human editor.

32. The medium of claim 29, wherein at least one feature is associated with the topical training data, the at least one feature being used to rank the query document pair.

33. The medium of claim 32, wherein:
said code to determine a general ranking for each query document pair further comprises code to use the at least one feature as input to the general ranking model to determine the general ranking for the query document pair; and
said code to train the topical ranking model further comprises code to train the topical ranking model to minimize the error with respect to the at least one feature.

34. The medium of claim 33, said code to train the topical ranking model further comprising:
code to train said topical ranking model to minimize an overall error associated with the topical training data as a whole.

35. The medium of claim 32, wherein the at least one feature is determined using a query portion of a query document pair.

36. The medium of claim 35, wherein the at least one feature is a semantic feature associated with the topical class.

37. The medium of claim 29, wherein the at least one feature has a first contribution to the general ranking score determined using the general ranking model for the query document pair, and has a second contribution to the topical ranking score determined using the topical ranking model for the query document pair, the second contribution being determined so as to minimize an error associated with the general ranking model.

38. The medium of claim 27, wherein the topical class has at least one topic, and wherein each query document pair in the topical training data is determined to relate to the at least one topic.

39. The medium of claim 38, said program code further comprising:
code to analyze a query portion of a candidate query document pair to identify topic information for the query; and
code to determine whether or not to include the candidate query document pair in the topical training data using the topical class' at least one topic and the topic information determined for the query.
